(19) United States
(12) Patent Application Publication
(10) Pub. No.: US 2008/0251603 A1
(43) Pub. Date: Oct. 16, 2008

(54) NOZZLE FOR PRESSURE WASHER OR LIQUID SPRAYER

(75) Inventor: Daniel D. Monty, Eagle, WI (US)

Correspondence Address: MICHAEL BEST & FRIEDRICH LLP, 100 E WISCONSIN AVENUE, Suite 3300, MILWAUKEE, WI, 53202, US

(73) Assignee: BRIGGS & STRATTON POWER PRODUCTS GROUP, LLC, Jefferson, WI (US)

(21) Appl. No.: 12/142,262

(22) Filed: Jun. 19, 2008

Related U.S. Application Data
(62) Division of application No. 11/071,773, filed on Mar. 3, 2005.

(51) Int. Cl. B67D 5/08

(52) U.S. Cl. 239/71

(57) ABSTRACT

A nozzle for use with a pressurized fluid delivery apparatus having an output device for discharging pressurized fluid includes a body portion configured to be coupled to the output device, an orifice supported by the body portion and through which the pressurized fluid is dischargeable, and a tactile indicator coupled to the body portion and configured to provide tactile feedback to a user to indicate a discharge characteristic of the nozzle.

### BACKGROUND

The present invention relates to pressure washers and liquid sprayers, and more particularly to nozzles for use with pressure washers and liquid sprayers.

Pressure washers are well known in the art to provide a highly-pressurized spray of water or other fluid, for cleaning or other purposes. Conventional pressure washers include a power unit (e.g., an engine) that drives a pump to provide the pressurized liquid to a rigid wand or other conduit. Nozzles are often coupled to the rigid wand to discharge the pressurized fluid from the rigid wand in a desired spray angle, output pressure, and/or flow rate. It is known to provide different nozzles to provide different discharge characteristics for spray exiting the nozzle.

### SUMMARY

Often times, the plurality of different nozzles are commingled when stored in a drawer, in the user's pocket, or in other storage devices. Existing pressure washer nozzles typically all look alike, making it difficult for the user to distinguish the discharge characteristics from one nozzle to the next. While it has been known to color-code nozzles or to label nozzles with a numerical indicator, a user must still typically cross-reference a key provided by the nozzle supplier in order to determine which nozzle provides the desired discharge characteristic.

The invention provides an improved pressure washer or liquid sprayer nozzle that more readily and more intuitively indicates to the user the discharge characteristic of the nozzle. The nozzle includes a tactile indicator that helps distinguish the nozzle from other similar nozzles that might be used with the pressure washer.

In one embodiment, the invention provides a nozzle for use with a pressurized fluid delivery apparatus having an output device for discharging pressurized fluid. The nozzle comprises a body portion configured to be coupled to the output device, an orifice supported by the body portion and through which the pressurized fluid is dischargeable, and a tactile indicator coupled to the body portion and configured to provide tactile feedback to a user to indicate a discharge characteristic of the nozzle.

In another embodiment, the invention provides a kit for use with a pressurized fluid delivery apparatus having an output device for discharging pressurized fluid. The kit comprises a first nozzle and a second nozzle individually connectable with the output device, each of the nozzles having a respective discharge characteristic, and wherein the first nozzle and the second nozzle include distinct tactile indicators configured to provide tactile feedback to a user to indicate a discharge characteristic of the respective nozzle.

In another embodiment, the invention provides a nozzle for use with a pressurized fluid delivery apparatus having an output device for discharging pressurized fluid. The nozzle comprises a body portion configured to be coupled to the output device, an orifice supported by the body portion and through which the pressurized fluid is dischargeable, and an indicator coupled to the body portion and that is at least partially angled with respect to a longitudinal axis of the nozzle to indicate a discharge characteristic of the nozzle.

Other aspects of the invention will become apparent by consideration of the detailed description and accompanying drawings.

### BRIEF DESCRIPTION OF THE DRAWINGS

FIG. 1 is a perspective view of a pressurized fluid delivery apparatus including a nozzle kit embodying the present invention.

FIG. 2 is an enlarged perspective view of a first nozzle of the nozzle kit illustrated in FIG. 1.

FIG. 2a is an enlarged perspective view of an alternative embodiment of the nozzle shown in FIG. 2.

FIG. 3 is a side view of the nozzle illustrated in FIG. 2.

FIG. 4 is a cross-sectional view of the nozzle illustrated in FIG. 2 taken along line 4-4 of FIG. 3.

FIG. 5 is a front view of the nozzle illustrated in FIG. 2.

FIG. 6 is an enlarged perspective view of a second nozzle of the nozzle kit illustrated in FIG. 1.

FIG. 7 is a side view of the nozzle illustrated in FIG. 6.

FIG. 8 is a front view of the nozzle illustrated in FIG. 6.

FIG. 9 is an enlarged perspective view of a third nozzle of the nozzle kit illustrated in FIG. 1.

FIG. 10 is a side view of the nozzle illustrated in FIG. 9.

FIG. 11 is a front view of the nozzle illustrated in FIG. 9.

FIG. 12 is an enlarged perspective view of a fourth nozzle of the nozzle kit illustrated in FIG. 1.

FIG. 13 is a side view of the nozzle illustrated in FIG. 12.

FIG. 14 is a front view of the nozzle illustrated in FIG. 12.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

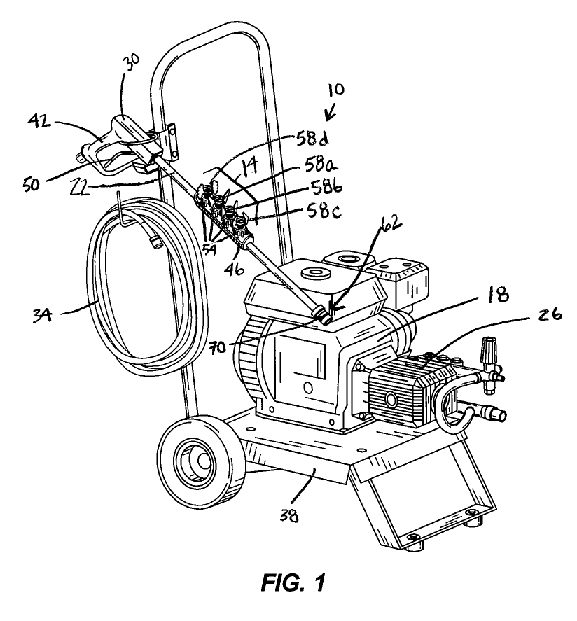

FIG. 1 illustrates a pressurized fluid delivery apparatus, or a pressure washer 10, incorporating a nozzle kit 14 of the present invention. The pressure washer 10 includes a power unit 18 to provide a pressurized fluid to an output device in the form of a rigid conduit or wand 22. The power unit 18 can be an engine, electric motor, or other power unit. A pump 26 is operatively coupled to the power unit 18 to provide the pressurized fluid. As understood in the art, the pump 26 can receive a supply of low-pressure fluid, pressurize the fluid, and discharge the pressurized fluid to the wand 22. In the illustrated construction, the pressure washer 10 does not utilize a regulator to regulate the pressure and flow of the fluid from the pump 26. Therefore, unregulated, pressurized fluid is discharged to the wand 22. Alternatively, the pressure washer 10 could include a regulator.

The wand 22 is coupled to a gun assembly 30 and acts as an extension to the gun assembly 30. The gun assembly 30 is fluidly connected with the pump 26 by a flexible hose 34, which allows the power unit 18 and pump 26 to remain in one place while the user moves around and operates the gun assembly 30. Any number of conventional fluid couplings may be used to fluidly connect and secure the hose 34 to the pump 26 and to the gun assembly 30, respectively. Further, the power unit 18 and pump 26 may be transportable by a wheeled frame or cart 38.

The gun assembly 30 includes a hand grip 42 for a user to grasp with one hand, and the wand 22 includes a handle 46 the user can grasp with the other hand. A trigger 50 is located near the hand grip 42 to allow the user to selectively operate the gun assembly 30.

As illustrated in FIG. 1, the handle 46 includes a plurality of bosses 54. The bosses 54 are configured to receive one or more fluid accessories in the form of nozzles 58a, 58b, 58c, 58d for storage. In the illustrated construction in FIG. 1, a quick-disconnect assembly 62 is used to interchangeably couple the nozzles 58a, 58b, 58c, 58d to the wand 22. The pressurized fluid exits the wand 22 via the nozzles 58a, 58b, 58c, 58d.

The quick-disconnect assembly 62 is operable to secure the nozzles 58a, 58b, 58c, 58d to the wand 22. As illustrated in FIGS. 1-14, each nozzle 58a, 58b, 58c, 58d includes a male fitting, or body portion 66a, 66b, 66c, 66d configured to be received in a female fitting 70 coupled to the wand 22. Other quick-disconnect assemblies can also be substituted. In yet other embodiments, the nozzles 58a, 58b, 58c, 58d can be attached to the wand 22 using tools.

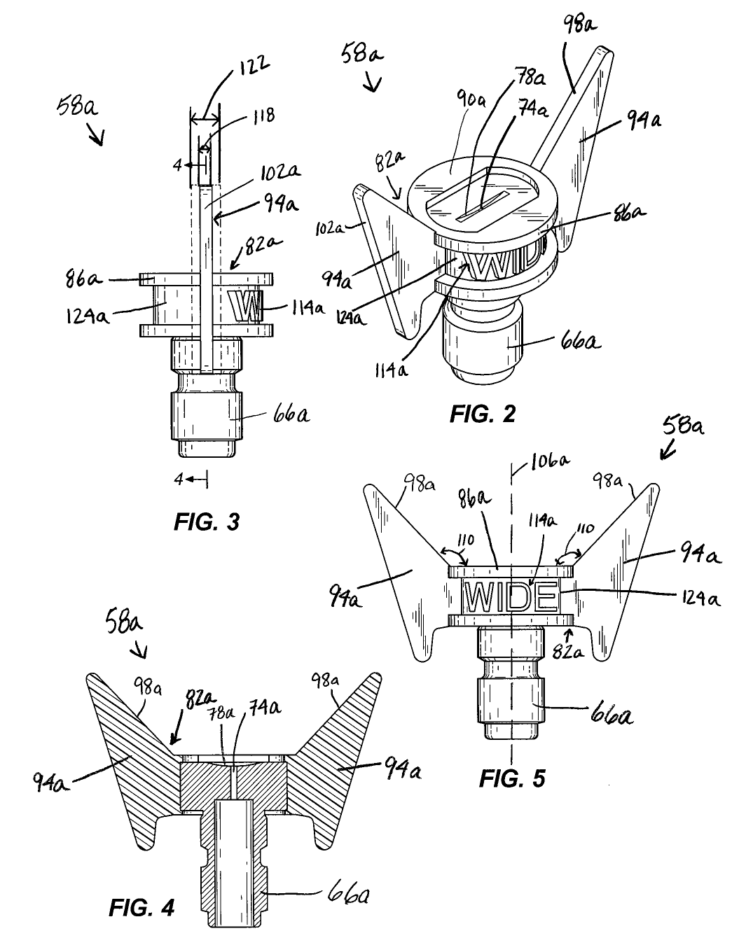

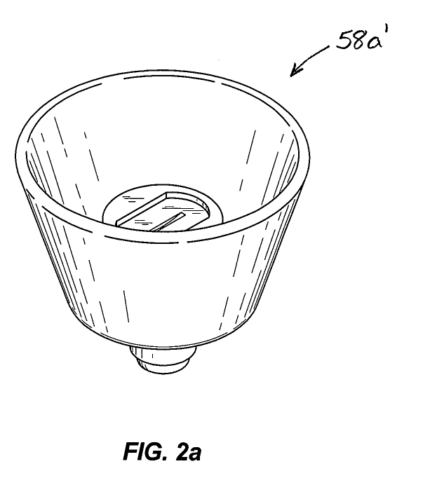

FIGS. 2-14 illustrate the nozzles 58a, 58b, 58c, 58d of the nozzle kit 14. The nozzle kit 14 includes at least two distinct nozzles, such as four nozzles 58a, 58b, 58c, 58d that are individually connectable with the wand 22. The nozzle kit 14 can also include a package (not shown) for housing the plurality of nozzles, such as nozzles 58a, 58b, 58c, 58d. The package may be made from any of a number of different materials, including, for example, plastic and cardboard. Alternatively, other materials may be used to make the package.

The nozzles 58a, 58b, 58c, 58d shown in FIGS. 1-14 are configured to create and/or accommodate respective different discharge characteristics of the pressurized fluid. Specifically, the nozzles 58a, 58b, 58c, 58d can create different output pressures, spray angles, and flow rates, and can accommodate different fluid compositions.

The nozzles 58a, 58b, 58c, 58d shown in FIGS. 1-14 include respective differently sized orifices 74a, 74b, 74c, 74d to discharge the pressurized fluid. The differently sized orifices 74a, 74b, 74c, 74d of the respective nozzles 58a, 58b, 58c, 58d define different flow rates and output pressures. The larger the orifice 74a, 74b, 74c, 74d, the lower the resulting output pressure, and the smaller the orifice 74a, 74b, 74c, 74d, the higher the resulting output pressure. Additionally, the larger the orifice 74a, 74b, 74c, 74d, the higher the flow rate and the smaller the orifice 74a, 74b, 74c, 74d, the lower the flow rate. For example, the nozzles 58a, 58b, 58c, 58d may include respective orifices 74a, 74b, 74c, 74d having nominal diameters of 1.3 mm, 1.2 mm, 1.15 mm, 1.1 mm, and 1.05 mm, which yield progressively smaller flow rates and thereby progressively larger output pressures. Alternatively, the nozzles 58a, 58b, 58c, 58d may be configured with respective orifices 74a, 74b, 74c, 74d having any number of different nominal diameters.

A nozzle kit 14 may contain two or more nozzles 58a, 58b, 58c, 58d with orifices 74a, 74b, 74c, 74d having equally sized diameters. However, if a nozzle, for example nozzle 58d, were present in the nozzle kit 14 specifically for use with a chemical such as detergent, the orifice size may be larger than the remainder of the nozzles 58a, 58b, 58c in the nozzle kit 14. Alternatively, if all of the orifices 74a, 74b, 74c, 74d have the same size, each nozzle 58a, 58b, 58c, 58d would provide substantially identical output pressures and flow rates, but each nozzle 58a, 58b, 58c, 58d would shape the discharged pressurized fluid into a spray pattern desirable for performing particular cleaning applications. For example, one of the nozzles 58a, 58b, 58c, 58d may be configured to provide a wide-angle spray pattern to clean a large surface at a low pressure, while another nozzle 58a, 58b, 58c, 58d may be configured to provide a narrow-angle spray pattern to clean a small surface at a high pressure. For example, nozzles 58a, 58b, 58c, 58d having orifices 74a, 74b, 74c, 74d with a diameter of 1.3 mm can each have different spray angles of 0 degrees, 15 degrees, 25 degrees, or 40 degrees. In general, for pressure washers, a spray angle of 0 degrees would be considered a “pinpoint” spray, a spray angle of 25 degrees would be considered a “medium” spray, and a spray angle of 40 degrees would be considered a “wide” spray. Having variation in spray angles for a pressure washer 10 is advantageous due to the disparity of applications for which a pressure washer may be used. The presence of a groove 78a, 78b, 78c, 78d or an alternative cut-out, can create the desired variations in the spray angle.

The nozzle kit 14 having two or more nozzles 58a, 58b, 58c, 58d with orifices 74a, 74b, 74c, 74d of the same diameter will allow the user of a pressure washer 10 to vary the spray angle at a known flow rate and pressure. Thus, the user may reconfigure the pressure washer 10 by merely changing the nozzles 58a, 58b, 58c, 58d to achieve a desired spray angle according to a particular application. Conventional pressure washers often require the user to adjust a pressure regulator to control the output pressure and flow of the discharged pressurized fluid, which can be troublesome for a user to achieve repeatable settings between adjustments. The combination of the pressure washer 10 and the nozzle kit 14 of the present invention allows the user to achieve repeatable settings of output pressure, flow rate, and spray angle of the discharged pressurized fluid.

One or more nozzles 58a, 58b, 58c, 58d of the nozzle kit 14 may be configured for use with chemicals being discharged from the pressure washer 10. The nozzle 58a, 58b, 58c, 58d for use with chemicals will generally have a relatively large orifice 74a, 74b, 74c, 74d and a medium spray angle. The large orifice 74a, 74b, 74c, 74d will help to prevent the chemical, such as a detergent, from clogging or restricting flow through the orifice 74a, 74b, 74c, 74d. The medium spray angle helps distribute the chemical more efficiently than would a pinpoint or wide angle spray. Additionally, having nozzles 58a, 58b, 58c, 58d for use specifically with chemicals will avoid incidence of spraying chemical residue on surfaces with the intention of spraying solely water.

Any combination of orifice sizes and spray angles can exist in a single nozzle kit 14. For example, a single nozzle kit 14 can have nozzles 58a, 58b, 58c, 58d having the same sized orifices 74a, 74b, 74c, 74d and different spray angles. In another embodiment, a single nozzle kit 14 could have nozzles 58a, 58b, 58c, 58d with differently sized orifices 74a, 74b, 74c, 74d all discharging at the same spray angle. Multiple nozzle kits can also be combined together to form customized nozzle kits.

Often times, the user will have a plurality of different nozzles in his pocket, in a pouch, in a drawer, or in another storage device. Finding the desired nozzle among the plurality of similar nozzles has previously been a difficult and time-consuming task. The present invention is directed to helping the user more intuitively differentiate between a plurality of nozzles so that he can quickly and easily locate and select the desired nozzle for the desired application. To achieve this end, the nozzles 58a, 58b, 58c, 58d in the nozzle kit 14 have tactile indicators to differentiate one or more properties of flow characteristics such as spray angle, output pressure, flow rate, and fluid composition between nozzles. As used herein and in the appended claims, the term “tactile” refers to a feature, characteristic, or the like that is perceptible and/or distinguishable by the sense of touch.

As shown in FIGS. 2-14, the nozzles 58a, 58b, 58c, 58d of the nozzle kit 14 each include respective body portions 66a, 66b, 66c, 66d that define respective orifices 74a, 74b, 74c, 74d, and respective tactile indicator portions 82a, 82b, 82c, 82d. The tactile indicator portions 82a, 82b, 82c, 82d each include a respective base 86a, 86b, 86c, 86d having a respective top surface 90a, 90b, 90c, 90d and two respective extension portions 94a, 94b, 94c, 94d. In the illustrated embodiment, each tactile indicator portion 82a, 82b, 82c, 82d is made of molded plastic, but can also be made of rubber, machined metal, or like material that can exhibit the desired properties and shapes. In the illustrated embodiment, the two extension portions 94a, 94b, 94c, 94d are diametrically opposed about the base 86a, 86b, 86c, 86d. In other embodiments, there could be only one, or more than two extension portions, or the extension portion could be a completely solid feature as shown in FIG. 2a depicting an alternative embodiment of a nozzle 58a′. A longitudinal axis 106a, 106b, 106c, 106d is defined by the respective body portions 66a, 66b, 66c, 66d of nozzles 58a, 58b, 58c, 58d.

A first nozzle 58a of the nozzle kit 14 is illustrated in FIGS. 2-5. Each extension portion 94a has an inner edge surface 98a and an outer edge surface 102a. The outer edge surface 102a is located radially outward from the inner edge surface 98a. Each inner edge surface 98a and each outer edge surface 102a are angled away from the longitudinal axis 106a to define an obtuse angle with the top surface 98a. The angle of the inner edge surface 98a with respect to the longitudinal axis 106a is indicative of the spray angle, which for the nozzle 58a is generally wide. As shown in FIG. 5, an angle 110 between the top surface 90a of the base 86a and the inner edge surface 98a of the extension portions 94a can vary between about 125 degrees and 145 degrees so that the inner edge surfaces 98a act as a tactile indicator representing a wide spray angle. The illustrated angle 110 is about 135 degrees.

With reference to FIG. 3, the outer edge surface 102a of the extension portions 94a of nozzle 54a defines a thickness 118. Alternatively, a larger thickness 122 (shown in phantom in FIG. 3) for the outer edge surface 102a is possible. The thickness 118, 122 of the extension portions 94a can vary to distinguish between flow rates. The thickness 118 of the extension portions 94a can exemplify a lower flow rate, and the thickness 122 of the extension portions 94a can exemplify a higher flow rate. Therefore, the thickness 118, 122 of the extension portions 94a will serve as a tactile indicator of the flow rate and thereby the orifice size. Alternatively, thickness 118, 122 of the extension portions 94a can directly indicate orifice size or discharge pressure. Although a difference in thickness 118, 122 of the extension portions 94a is only shown for nozzle 58a in FIG. 3, any or none of the nozzles 58a, 58b, 58c, 58d can have a variable thickness of the extension portions 94a, 94b, 94c, 94d to represent any one of the flow characteristics, including but not limited to, flow rate or output pressure. An explanation of the variations in thickness of the extension portions 94a, 94b, 94c, 94d can be given on or with the nozzle kit 14 packaging or on the nozzles themselves.

The texture of the outer edge surfaces 102a of the extension portions 94a of the nozzle 58a is generally smooth. The smoothness can act as a tactile indicator to a user of the fluid composition associated with the nozzle 58a. For example, extension portions 94a having a smooth surface can indicate water exiting the nozzle 58a and extension portions 94a having a second texture (as will be discussed below with respect to nozzle 58d) can indicate a chemical or a chemical and water solution exiting the nozzle 58a. Alternatively or additionally, the texture could also be used indicate flow rates, output pressures, or spray angles (e.g., small “bumps” could indicate a low flow rate, a low output pressure, or a small spray angle, and large “bumps” could indicate a high flow rate, a high output pressure, or a large spray angle).

The unique three-dimensional shape of the nozzle 58a as illustrated in FIGS. 2-5 also provides an intuitive visual indicator to the user as to the specific discharge characteristics associated with nozzle 58a. Additionally, the nozzles 58a, 58b, 58c, 58d of FIGS. 2-14 can also include indicia 114a, 114b, 114c, 114d in the form of text or other imagery describing the spray angle or other discharge characteristic (e.g., output pressure, flow rate, fluid composition). As illustrated in FIGS. 2-14, text describing the spray angle is located in a reduced diameter portion 124a, 124b, 124c, 124d of the tactile indicator portion 82a, 82b, 82c, 82d. As illustrated, the indicia 114 can be raised so the letters can act as both a visual and tactile indicator. Further, other visual indicators may be used with the nozzles 58a, 58b, 58c, 58d to allow a user to correlate a particular nozzle 58a, 58b, 58c, 58d with a particular discharge characteristic. For example, the nozzles 58a, 58b, 58c, 58d may be labeled with symbols, letters, words, colors, and/or numbers to provide a visual indicator to the user which nozzle 58a, 58b, 58c, 58d is associated with which discharge characteristic. Such symbols, letters, colors, and/or numbers may be integrally formed with the nozzles 58a, 58b, 58c, 58d, or may be printed on stickers or labels that are applied to the nozzles 58a, 58b, 58c, 58d.

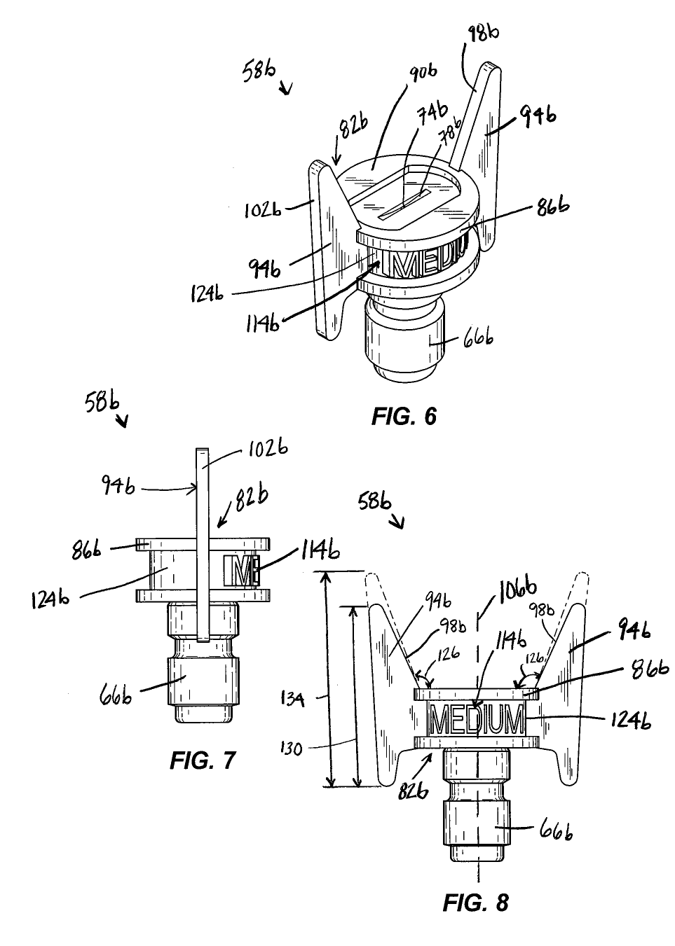

FIGS. 6-8 illustrate another nozzle 58b of the nozzle kit 14. Similar elements are identified with like reference numerals, designated with the letter “b.” Differences between the nozzle 58b and nozzle 58a will be discussed below.

The orientations of the inner edge surfaces 98b and the outer edge surfaces 102b are different from the nozzle 58a to yield a different tactile representation of the discharge characteristic of the nozzle 58b. Each inner edge surface 98b is angled away from the longitudinal axis 106b to create an obtuse angle with the top surface 90b that is less than the obtuse angle created by the inner edge surface 98a of the nozzle 58a. The angle of the inner edge surface 98b is indicative of the spray angle, which for this nozzle 58b is generally medium. As shown in FIG. 8, an angle 126 between the top surface 90b of the base 86b and the inner edge surface 98b of the extension portions 94b can vary between about 100 degrees and 120 degrees as a tactile indicator for the medium spray angle. The illustrated angle 126 is about 110 degrees. The outer edge surface 102b is parallel to or nearly parallel to the longitudinal axis 106b extending through the body portion 66b of the nozzle 58b. The generally parallel outer edge surface 102b also serves as a tactile indicator to differentiate the nozzle 58b from nozzle 58a.

Referring to FIG. 8, the extension portions 94b have a length 130. Alternatively, a longer length 134 (shown in phantom in FIG. 8) of the extension portions 94b is possible. The length 130, 134 of the extension portions 94b can vary to distinguish between discharge pressures. The length 130 of the extension portions 94b can exemplify a lower discharge pressure, and the length 134 of the extension portions 94b can exemplify a higher discharge pressure. Therefore, the length 130, 134 of the extension portions 94b will serve as a tactile indicator of the discharge pressure and thereby the orifice size. Alternatively, the length 130, 134 of the extension portions 94b can directly indicate orifice size or flow rate. Although a difference in length 130, 134 of the extension portions 94b is only shown for nozzle 58b in FIG. 8, any or none of the nozzles 58a, 58b, 58c, 58d can have a variable length 130, 134 of the extension portions 94a, 94b, 94c, 94d to represent any one of the flow characteristics, including but not limited to, flow rate or output pressure. An explanation of the variations in length of the extension portions 94a, 94b, 94c, 94d on nozzles 58a, 58b, 58c, 58d can be given on or with the nozzle kit 14 packaging or on the nozzles themselves.

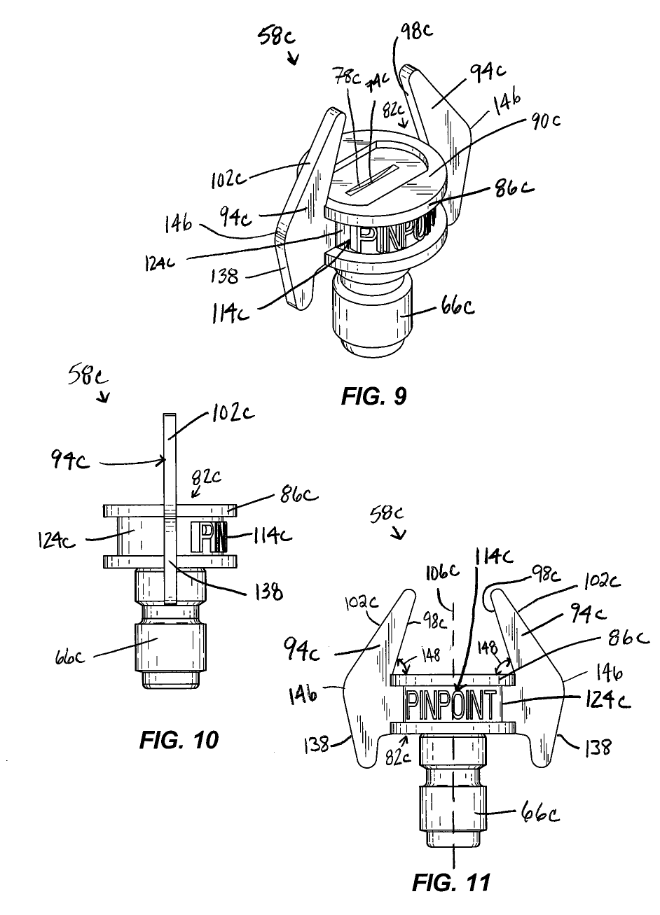

FIGS. 9-11 illustrate another nozzle 58c of the nozzle kit 14 similar to the nozzles 58a, 58b of FIGS. 2-8. Similar elements are identified with like reference numerals, designated with the letter “c.” Differences between the nozzle 58c and nozzles 58a, 58b will be discussed below.

The orientations of the inner edge surfaces 98c and the outer edge surfaces 102c are different from the nozzles 58a, 58b to yield a different tactile representation of the discharge characteristic of the nozzle 58c. The inner edge surface 98c is angled inwardly toward the longitudinal axis 106c to create an acute angle with the top surface 90c. As shown in FIG. 11, an angle 148 between the top surface 90c of the base 86c and the inner edge surface 98c of extension portion 94c can vary between about 65 degrees and 85 degrees as a tactile indicator for the pinpoint spray angle. The illustrated angle 148 is about 75 degrees. The outer edge surface 102c is parallel to or nearly parallel to the inner edge surface 98c, and is also angled toward the longitudinal axis 106c. In addition, the nozzle 58c has a lower outer edge surface 138. The inwardly bending extension portions 94c, in addition to a bend 146 that is formed between the outer edge surfaces 102c and the lower outer edge surfaces 138, are tactile indicators to the user of the nozzle's pinpoint spray angle.

In addition to the configuration of the tactile indicator 82c, the color of the tactile indicator can be varied to further indicate to the user the discharge characteristics of the nozzles. For example, the tactile indicators of pinpoint spray nozzles (e.g., the nozzle 58c) can be colored red to indicate to the user the potential for damage associated with using a nozzle having a pinpoint spray angle. Nozzles creating a medium spray angle (e.g., the nozzle 58b) could have a yellow tactile indicator to indicate caution should be used, while nozzles creating a wide spray angle (e.g., the nozzle 58a) could have a green tactile indicator to indicate that use of this nozzle is not likely to cause damage to the surface being sprayed. Alternatively, the color red could be used for all tactile indicators associated with nozzles producing a high discharge pressure or high flow rate (regardless of the spray angle), while yellow or green indicators could be used on nozzles producing lower discharge pressures or flow rates.

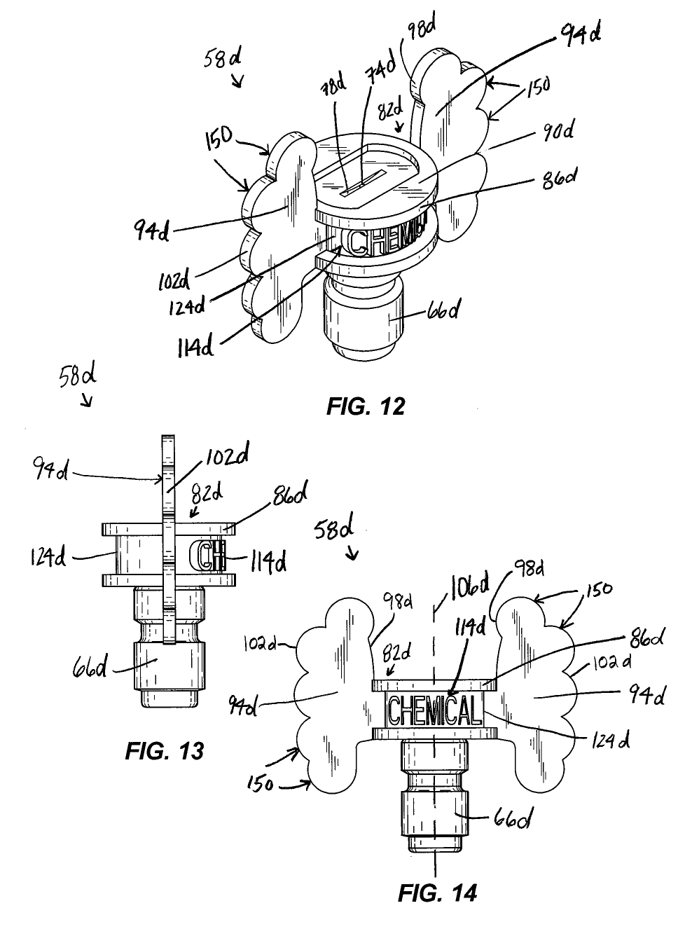

FIGS. 12-14 illustrate another nozzle 58d of the nozzle kit 14 similar to the nozzles 58a, 58b, 58c of FIGS. 2-11. Similar elements are identified with like reference numerals, designated with the letter “d.” Differences between nozzle 58d and nozzles 58a, 58b, 58c will be discussed below.

The nozzle 58d is for use with chemicals and therefore may have different properties such as orifice size and spray angle. The nozzle 58d has two extension portions 94d having textured outer edge surfaces 102d such that a user would feel a series of rounded segments 150. The rounded segments 150 are indicative of bubbles for a detergent or other chemical, and serve as a tactile indicator to the user of a discharge characteristic such as fluid composition. The nozzle 58d having rounded segments 150 on the extension portions 94d can indicate a nozzle 58d for use with chemicals while a nozzle 58a, 58b, 58c having generally smooth extension outer edge surfaces 102a, 102b, 102c can indicate a nozzle 58a, 58b, 58c for use with only water.

Each inner edge surface 98d is generally parallel to the longitudinal axis 106d. However, the angle of the inner edge surfaces 98d could vary as desired. In the illustrated embodiment, the spray angle associated with the nozzle 58d can be the medium spray angle of about 25 degrees, or could be other suitable angles.

Unlike with the nozzles 58a, 58b, 58c where the indicia 114 describes the spray angle, the indicia 114d takes the form of text spelling “CHEMICAL”, thereby providing another indicator to the user, in addition to the textured outer edge surfaces 102d, that the nozzle 58d is intended for use with a chemical additive in the discharge spray.

The presence of the tactile indicators 82a, 82b, 82c, and 82d enables the user to quickly and easily select the desired nozzle from a plurality of nozzles that might be commingled during storage and/or use. In addition to enabling the user to distinguish between nozzles using the sense of touch, the indicators 82a, 82b, 82c, and 82d can also act as visual indicators that allow the user to intuitively determine and/or differentiate the discharge characteristics of the nozzles without the need to reference a chart or key. It is to be understood that the different indicating features described above can be used alone or in any desired combination to provide the most intuitive indications of the nozzle discharge characteristics to the user. The illustrated indicator portions 82a, 82b, 82c, and 82d represent only some of the configurations contemplated by the present invention.

Various features and advantages of the invention are set forth in the following claims.

1-14. (canceled)

15. A kit for use with a pressurized fluid delivery apparatus having an output device for discharging pressurized fluid, the kit comprising:
a first nozzle including
a first body connectable with the output device;
a first orifice in the first body;
a first tactile indicator coupled to the first body and indicative of the size of the first orifice;
a second nozzle including
a second body connectable with the output device;
a second orifice in the second body;
a second tactile indicator coupled to the second body and indicative of the size of the second orifice;
wherein the size of the second orifice is different from the size of the first orifice.

16. The kit of claim 34, wherein the first tactile indicator is at least partially angled with respect to a longitudinal axis of the first nozzle at a first angle, and wherein the second tactile indicator is at least partially angled with respect to a longitudinal axis of the second nozzle at a second angle that is different from the first angle.

17. The kit of claim 16, wherein the first and second angles are indicative of first and second spray angles provided by the respective first and second grooves; and wherein the second spray angle is different than the first spray angle.

18. (canceled)

19. (canceled)

20. The kit of claim 15, wherein the first tactile indicator includes a first portion having a first length, and wherein the second tactile indicator includes a second portion having a second length that is different from the first length.

21. (canceled)

22. The kit of claim 15, wherein the first tactile indicator includes a first portion having a first thickness, and wherein the second tactile indicator includes a second portion having a second thickness that is different from the first thickness.

23. (canceled)

24. The kit of claim 15, wherein each of the first and second nozzles further includes a different visual indicator configured to provide visual feedback to a user to indicate the respective nozzle the respective sizes of the first orifice and the second orifice.

25. The kit of claim 24, wherein each visual indicator includes at least one of a color, an icon, and an alphanumerical system.

26. The kit of claim 24, wherein the first and second tactile indicators are each configured to also function as the visual indicator on the respective first and second nozzles.

27-33. (canceled)

34. A kit for use with a pressurized fluid delivery apparatus having an output device for discharging pressurized fluid, the kit comprising:
a first nozzle including
a first body connectable with the output device;
a first orifice in the first body;
a first groove in the first body positioned adjacent the first orifice;
a first tactile indicator coupled to the first body and indicative of the size of the first groove;
a second nozzle including
a second body connectable with the output device;
a second orifice in the second body;
a second groove in the second body positioned adjacent the second orifice; and
a second tactile indicator coupled to the second body and indicative of the size of the second groove;
wherein the size of the second groove is different from the size of the first groove.

35. The kit of claim 34, wherein each of the first and second nozzles further includes a different visual indicator configured to provide visual feedback to a user to indicate the respective sizes of the first groove and the second groove.

36. The kit of claim 35, wherein each visual indicator includes at least one of a color, an icon, and an alphanumerical system.

37. The kit of claim 35, wherein the first and second tactile indicators are each configured to also function as the visual indicator on the respective first and second nozzles.

38. The kit of claim 34, wherein the size of the second orifice is substantially similar to the size of the first orifice.
